(19) United States
(12) Patent Application Publication
(10) Pub. No.: US 2006/0097640 A1
(43) Pub. Date: May 11, 2006

(54) Plasma display panel

(75) Inventors: Hidekazu Hatanaka, Suwon-si (KR); Young-Mo Kim, Suwon-si (KR); Ho-Nyeon Lee, Suwon-si (KR); Sang-Hun Jang, Suwon-si (KR); Seung-Hyun Son, Suwon-si (KR); Seong-Eui Lee, Suwon-si (KR); Hyoung-Bin Park, Suwon-si (KR); Gi-Young Kim, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/268,451

(22) Filed: Nov. 8, 2005

(30) Foreign Application Priority Data
Nov. 9, 2004 (KR) 10-2004-0090891

(51) Int. Cl. H01J 17/49

(52) U.S. Cl. 313/587

(57) ABSTRACT

A plasma display panel includes a lower substrate and an upper substrate facing each other. A plurality of barrier ribs is arranged between the lower substrate and the upper substrate and partitions the discharge space to form a plurality of discharge cells. First and second sustaining electrodes are formed as pairs in the discharge cells on the upper substrate, and third and fourth sustaining electrodes, which are arranged in the barrier ribs, are formed as pairs facing each other in the discharge cells. A surface discharge occurs between the first and second sustaining electrodes, and a facing discharge occurs between the third and fourth sustaining electrodes.

### CROSS-REFERENCE TO RELATED APPLICATION

This application claims priority to and the benefit of Korean Patent Application No. 10-2004-0090891, filed on Nov. 9, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP with reduced discharge voltage and improved luminous efficiency.

2. Discussion of the Background

Generally, a plasma display panel (PDP) forms an image using an electrical discharge. Its superior performance in terms of brightness and viewing angle has ensured its popularity. In a PDP, applying a direct current (DC) or alternating current (AC) voltage to electrodes causes a gas discharge between the electrodes, thereby generating ultraviolet rays that excite a fluorescent material, which emits visible light to form images.

PDPs may be DC PDPs or AC PDPs, according to discharge cell structure. The DC PDP has a structure in which all electrodes are exposed to a discharge space, and charges move directly between the electrodes. The AC PDP has a structure in which at least one electrode is covered with a dielectric layer, and charges do not move directly between the corresponding electrodes. Rather, discharge is performed by wall charges.

Also, PDPs may be facing discharge PDPs or surface discharge PDPs according to electrode arrangement. The facing discharge PDP has a pair of sustain electrodes including one electrode formed on an upper substrate and one electrode formed on a lower substrate, and discharge occurs perpendicular to the substrates. The surface discharge PDP has a pair of sustain electrodes that are formed on the same substrate, and discharge occurs parallel to the substrate.

FIG. 1 is an exploded perspective view of a conventional surface discharge PDP. FIG. 2A and FIG. 2B are vertical and horizontal cross sections of the PDP of FIG. 1, respectively.

Referring to FIG. 1, FIG. 2A, and FIG. 2B, the conventional surface discharge PDP includes a lower substrate 10 and an upper substrate 20 facing each other at a predetermined distance. The space between the substrates is a discharge space in which plasma discharge occurs.

A plurality of address electrodes 11 are formed on the upper surface of the lower substrate 10. A first dielectric layer 12 covers the address electrodes 11. Barrier ribs 35 are arranged on the first dielectric layer 12 to partition the discharge space into a plurality of discharge cells 30. The barrier ribs 35 also prevent electrical and optical cross-talk between adjacent discharge cells 30. A discharge gas is filled in the discharge cells 30, and a fluorescent layer 15 is coated to a predetermined thickness on the first dielectric layer 12 and the side walls of the barrier ribs 35, which form the inner walls of the discharge cells 30.

The upper substrate 20 is transparent so that it may transmit visible light, and it is typically formed of glass. The upper substrate 20 is coupled with the lower substrate 10 having the barrier ribs 35. Pairs of sustaining electrodes 21a and 21b are formed on the lower surface of the upper substrate 20, and they are arranged to perpendicularly cross the address electrodes 11. The sustaining electrodes 21a and 21b are formed of a transparent conductive material, such as indium tin oxide (ITO), to transmit visible light. Metallic bus electrodes 22a and 22b, which are narrower than the sustaining electrodes 21a and 21b, are formed on the sustaining electrodes 21a and 21b to reduce their line resistance. A transparent second dielectric layer 23 covers the sustaining electrodes 21a and 21b and the bus electrodes 22a and 22b, and a protective layer 24 covers the second dielectric layer 23. The protective layer 24 prevents the second dielectric layer 23 from being damaged by plasma sputtering, and it emits secondary electrons during discharge, thereby lowering discharge voltages. The protective layer 24 may be formed of magnesium oxide (MgO).

In the conventional PDP described above, the electric field formed between the sustaining electrodes may be non-uniform, thereby lowering luminous efficiency. Additionally, although widening the distance between the sustaining electrodes lengthens the discharge path and improves luminous efficiency, it also increases the discharge voltage.

While the facing discharge PDP may have high luminous efficiency due to formation of a uniform electric field, plasma may easily deteriorate the fluorescent layer. Luminous efficiency may be enhanced by widening the distance between the sustaining electrodes. However, in this case, this widening will also result in an increased discharge voltage.

### SUMMARY OF THE INVENTION

The present invention provides a PDP with an improved structure that may lower the discharge voltage while improving luminous efficiency.

Additional features of the invention will be set forth in the description which follows, and in part will be apparent from the description, or may be learned by practice of the invention.

The present invention discloses a PDP including a lower substrate and an upper substrate facing each other with a discharge space therebetween, a plurality of barrier ribs arranged between the lower substrate and the upper substrate and partitioning the discharge space to form a plurality of discharge cells, a plurality of address electrodes arranged on the lower substrate, a first dielectric layer covering the address electrodes, and a fluorescent layer arranged on the first dielectric layer. First and second sustaining electrodes are formed in the discharge cells and on the upper substrate, and a second dielectric layer covers the first and second sustaining electrodes. Third and fourth sustaining electrodes face each other in the discharge cells, and they are arranged in the barrier ribs. A surface discharge occurs between the first and second sustaining electrodes, and a facing discharge occurs between the third and fourth sustaining electrodes.

The present invention also discloses a PDP including a lower substrate and an upper substrate facing each other with a discharge space therebetween, a plurality of barrier ribs is arranged between the lower substrate and the upper substrate and partitioning the discharge space to form a plurality of discharge cells, a plurality of address electrodes arranged on the upper substrate, a first dielectric layer covering the address electrodes and a fluorescent layer arranged on the first dielectric layer. First and second sustaining electrodes are formed in the discharge cells and on the lower substrate, and a second dielectric layer covers the first and second sustaining electrodes. Third and fourth sustaining electrodes are formed facing each other in the discharge cells, and they are arranged in the barrier ribs. A surface discharge occurs between the first and second sustaining electrodes, and a facing discharge occurs between the third and fourth sustaining electrodes.

The present invention also discloses a PDP including a lower substrate and an upper substrate facing each other with a discharge space therebetween, a plurality of barrier ribs arranged between the lower substrate and the upper substrate and partitioning the discharge space to form a plurality of discharge cells, a plurality of address electrodes arranged on the lower substrate, a first dielectric layer covering the address electrodes, and a fluorescent layer arranged on the first dielectric layer. First and second sustaining electrodes face each other in the discharge cells, and they are arranged in the barrier ribs. Second and third dielectric layers are formed on the upper substrate spaced apart from each other, and they are coupled with the first and second sustaining electrodes, respectively, so that voltages are induced to the second and third dielectric layers as voltages are applied to the first and second sustaining electrodes. A facing discharge occurs between the first and second sustaining electrodes, and a surface discharge occurs between the second and third dielectric layers.

The present invention also discloses a PDP including a lower substrate and an upper substrate facing each other with a discharge space therebetween, a plurality of barrier ribs arranged between the lower substrate and the upper substrate and partitioning the discharge space to form a plurality of discharge cells, a plurality of address electrodes arranged on the upper substrate, a first dielectric layer covering the address electrodes, and a fluorescent layer arranged on the first dielectric layer. First and second sustaining electrodes face each other in the discharge cells, and they are arranged in the barrier ribs, Second and third dielectric layers are formed on the lower substrate spaced apart from each other, and they are coupled with the first and second sustaining electrodes, respectively, so that voltages are induced to the second and third dielectric layers as voltages are applied to the first and second sustaining electrodes. A facing discharge occurs between the first and second sustaining electrodes, and a surface discharge occurs between the second and third dielectric layers.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a conventional surface discharge PDP.

FIG. 2A and FIG. 2B are vertical and horizontal cross sectional views of the PDP of FIG. 1, respectively.

FIG. 3 is a cross sectional view of a PDP according to a first exemplary embodiment of the present invention.

FIG. 4 is a cross sectional view showing a modification of the PDP of FIG. 3.

FIG. 5 is a cross sectional view of a PDP according to a second exemplary embodiment of the present invention.

FIG. 6 is a cross sectional view showing a modification of the PDP of FIG. 5.

FIG. 7 is a cross sectional view of a PDP according to a third exemplary embodiment of the present invention.

FIG. 8 is a cross sectional view of a PDP according to a fourth exemplary embodiment of the present invention.

FIG. 9 is a cross sectional view of a PDP according to a fifth exemplary embodiment of the present invention.

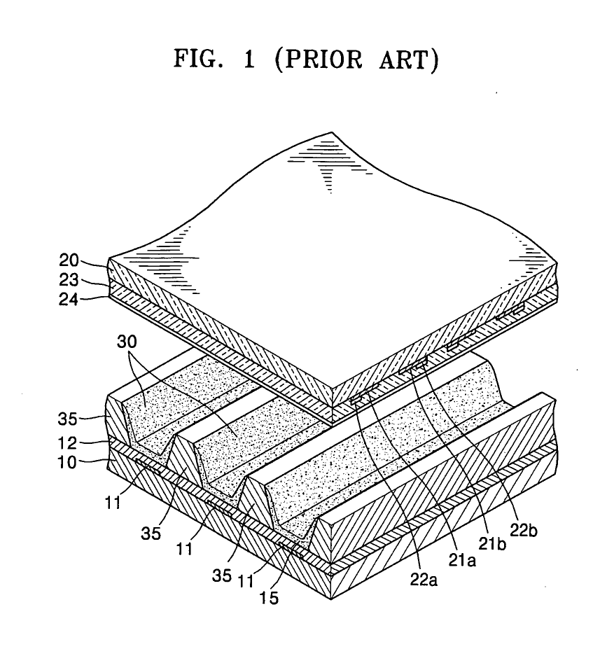

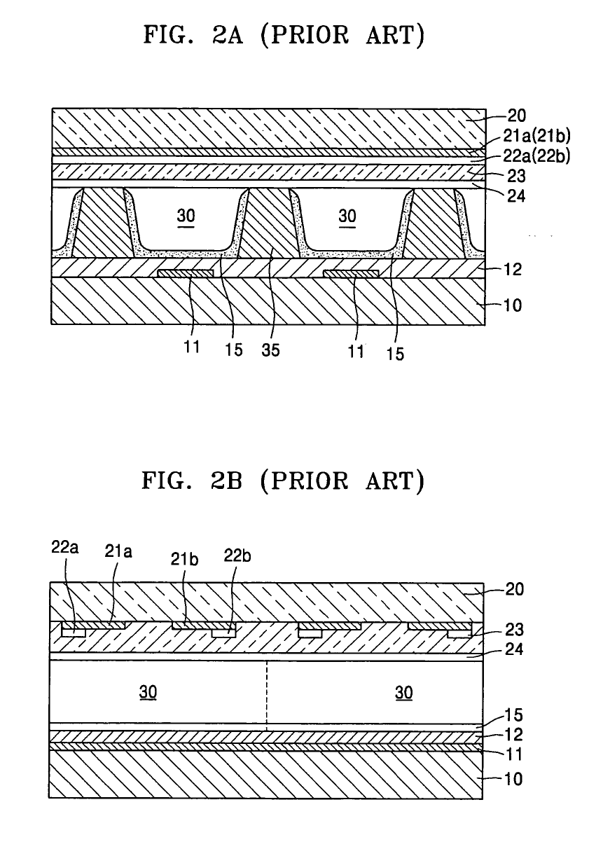

### DETAILED DESCRIPTION OF THE ILLUSTRATED EMBODIMENTS

The present invention will now be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

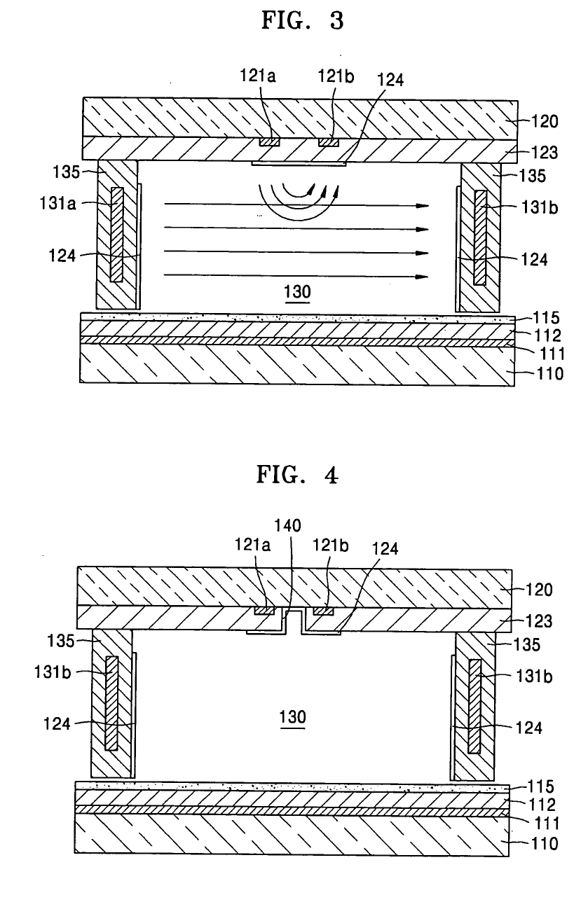

FIG. 3 is a cross sectional view of a PDP according to a first exemplary embodiment of the present invention.

Referring to FIG. 3, a lower substrate 110 and an upper substrate 120 face each other at a predetermined distance with a discharge space therebetween. The lower substrate 110 and the upper substrate 120 may be mainly glass substrates.

A plurality of address electrodes 111 is formed on the lower substrate 110, and a first dielectric layer 112 covers the address electrodes 111. Additionally, a fluorescent layer 115 is formed on the first dielectric layer 112.

A plurality of barrier ribs 135, which partition the discharge space to form discharge cells 130, is arranged between the lower substrate 110 and the upper substrate 120. The barrier ribs 135 are arranged substantially perpendicular to the address electrodes 111, and they prevent electrical and optical cross-talk between adjacent discharge cells 130. A discharge gas, which emits ultraviolet rays by plasma discharge, is filled in the discharge cells 130. Although not illustrated in FIG. 3, a reflective layer may be formed on the lower substrate 110 to reflect visible light generated in the discharge cells 130 towards the upper substrate 120.

A pair of adjacent first and second sustaining electrodes 121a and 121b is arranged on the upper substrate 120 in the discharge cells 130. The first and second sustaining electrodes 121a and 121b are arranged to cross the address electrodes 111. A second dielectric layer 123 covers the first and second sustaining electrodes 121a and 121b.

Third and fourth sustaining electrodes 131a and 131b are arranged in and along the length of adjacent barrier ribs 135. The third and fourth sustaining electrodes 131a and 131b are formed in pairs and to face each other in the discharge cells 130.

A protective layer 124 is arranged on the surface of the second dielectric layer 123 corresponding to the first and second sustaining electrodes 121a and 121b and on the surface of the barrier ribs 135 corresponding to the third and fourth sustaining electrodes 131a and 131b. The protective layer 124 prevents damage to the second dielectric layer 123 by plasma sputtering, and it emits secondary electrons during discharge, thereby lowering discharge voltages. The protective layer 124 may be made of magnesium oxide (MgO).

In the PDP described above, when applying a predetermined voltage to the first and second sustaining electrodes 121a and 121b, and the third and fourth sustaining electrodes 131a and 131b, respectively, a start discharge occurs between the first and second sustaining electrodes 121a and 121b, which are adjacent to each other. Further, after the start discharge, a sustain discharge occurs between the first and second sustaining electrodes 121a and 121b and between the third and fourth sustaining electrodes 131a and 131b. Hence, a hybrid discharge occurs inside the discharge cells 130. The hybrid discharge is a combination of a surface discharge, which is caused by an electric field formed between the first and second sustaining electrodes 121a and 121b, and a facing discharge, which is caused by an electric field formed between the third and fourth sustaining electrodes 131a and 131b.

As such, in the PDP according to the present embodiment, a field enhancement effect may be obtained by including facing third and fourth sustaining electrodes 131a and 131b in addition to the first and second sustaining electrodes 121a and 121b, which are arranged on the upper substrate 120. Accordingly, a substantially uniform electric field may be formed inside the discharge cells 130, thereby improving the PDP's luminous efficiency.

FIG. 4 is a cross sectional view showing a modification of the PDP of FIG. 3. Only features of the modified PDP that differ from the PDP of FIG. 3 will be described below.

Referring to FIG. 4, a trench 140 of a predetermined shape is formed in a portion of the second dielectric layer 123 between the first and second sustaining electrodes 121a and 121b. The trench 140 is formed substantially parallel to the first and second sustaining electrodes 121a and 121b. The protective layer 124 is arranged on the inner walls of the trench 140. As such, if the trench 140 is formed in the second dielectric layer 123, a field concentration effect may be achieved. Consequently, the start discharge voltage may be further reduced.

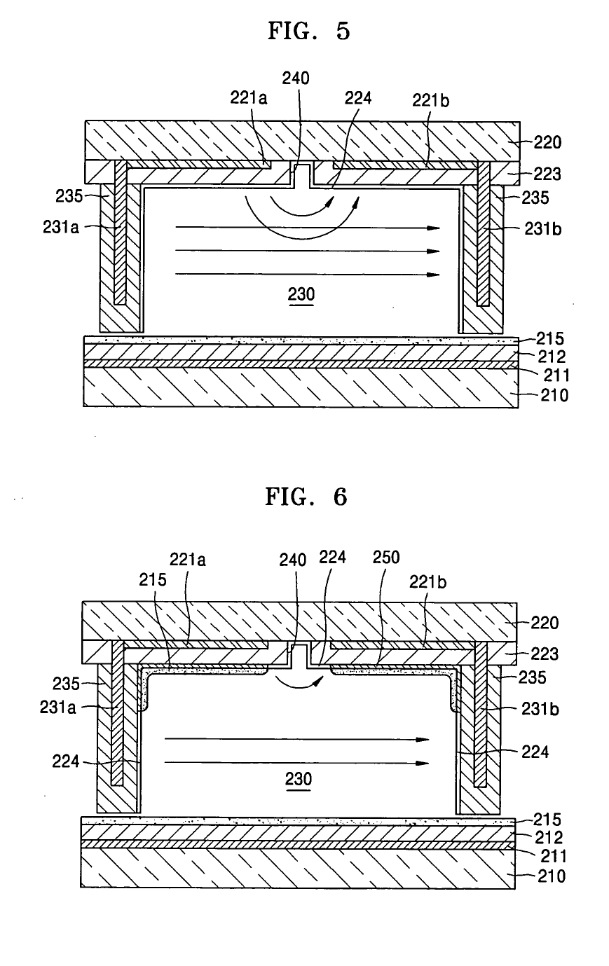

FIG. 5 is a cross sectional view of a PDP according to a second exemplary embodiment of the present invention.

Referring to FIG. 5, a lower substrate 210 and an upper substrate 220 face each other at a predetermined distance with a discharge space therebetween. A plurality of address electrodes 211 is formed on the lower substrate 210, and a first dielectric layer 212 covers the address electrodes 211. Additionally, a fluorescent layer 215 is formed on the first dielectric layer 212.

A plurality of barrier ribs 235, which partition the discharge space to form discharge cells 230, is arranged between the lower substrate 210 and the upper substrate 220. The barrier ribs 235 are arranged substantially perpendicular to the address electrodes 211, and they prevent electrical and optical cross-talk between adjacent discharge cells 230. Although not illustrated in FIG. 5, a reflective layer may be formed on the lower substrate 210 to reflect visible light generated in the discharge cells 230 towards the upper substrate 220.

First and second sustaining electrodes 221a and 221b are formed in pairs on the upper substrate 220 in the discharge cells 230, and they are arranged to cross the address electrodes 211. The first and second sustaining electrodes 221a and 221b are made of a transparent conductive material, such as indium tin oxide (ITO) or tin dioxide (SnO₂), so that visible light generated from the discharge cells 230 may pass through the upper substrate 220. A transparent second dielectric layer 223 covers the first and second sustaining electrodes 221a and 221b. Further, a trench 240 of a predetermined shape may be formed substantially parallel to the first and second sustaining electrodes 221a and 221b in a portion of a second dielectric layer 223 between the first and second sustaining electrodes 221a and 221b.

Third and fourth sustaining electrodes 231a and 231b are arranged in and along the length of adjacent barrier ribs 235. The third and fourth electrodes 231a and 231b are formed in pairs and to face each other in the discharge cells 230. The third and fourth sustaining electrodes 231a and 231b may be formed of a metal such as Ag. Furthermore, the third and fourth sustaining electrodes 231a and 231b may be electrically connected with the first and 20 second sustaining electrodes 221a and 221b, respectively. In this case, the third and fourth sustaining electrodes 231a and 231b act as bus electrodes of the first and second sustaining electrodes 221a and 221b, respectively.

A protective layer 224 is arranged on the second dielectric layer 223, which covers the first and second sustaining electrodes 221a and 221b, and on the barrier ribs 235, in which the third and fourth sustaining electrodes 231a and 231b are formed.

In the PDP described above, when applying a predetermined voltage to the third and fourth sustaining electrodes 231a and 231b, a start discharge occurs between the first and second sustaining electrodes 221a and 221b, which are electrically connected with the third and fourth sustaining electrodes 231a and 231b, respectively. Further, after the start discharge, a sustain discharge occurs between the first and second sustaining electrodes 221a and 221b and between the third and fourth sustaining electrodes 231a and 231b. Here, as described in the previous embodiment, a hybrid discharge, which is a combination of surface and facing discharges, occurs in the discharge cells 230. Since the first and second sustaining electrodes 221a and 221b are made of a transparent conductive material, most of visible light generated from the discharge cells 230 may transmit through the upper substrate 220, thereby improving the PDP's brightness and luminous efficiency. Additionally, the discharge voltage may be reduced by the field enhancement effect, and luminous efficiency may be improved due to the formation of a substantially uniform electric field.

FIG. 6 is a cross sectional view showing a modification of the PDP of FIG. 5. Only features of the modified PDP that differ from the PDP of FIG. 5 will be described below.

Referring to FIG. 6, a discharge deactivation film (DDF) 250 is arranged on portions of the second dielectric layer 223 corresponding to the first and second sustaining electrodes 221a and 221b. The DDF 250 may extend to be arranged on a portion of the barrier ribs 235. The DDF 250 may be formed of aluminum oxide (Al₂O₃), and it may reduce a secondary electron emission coefficient and sputter yield. Accordingly, the PDP's power consumption may be decreased.

A fluorescent layer 215 may be formed on the surface of the DDF 250 to generate more visible light during discharge. Additionally, a protective layer 224 may be formed on the exposed portions of the second dielectric layer 223 and the barrier ribs 235.

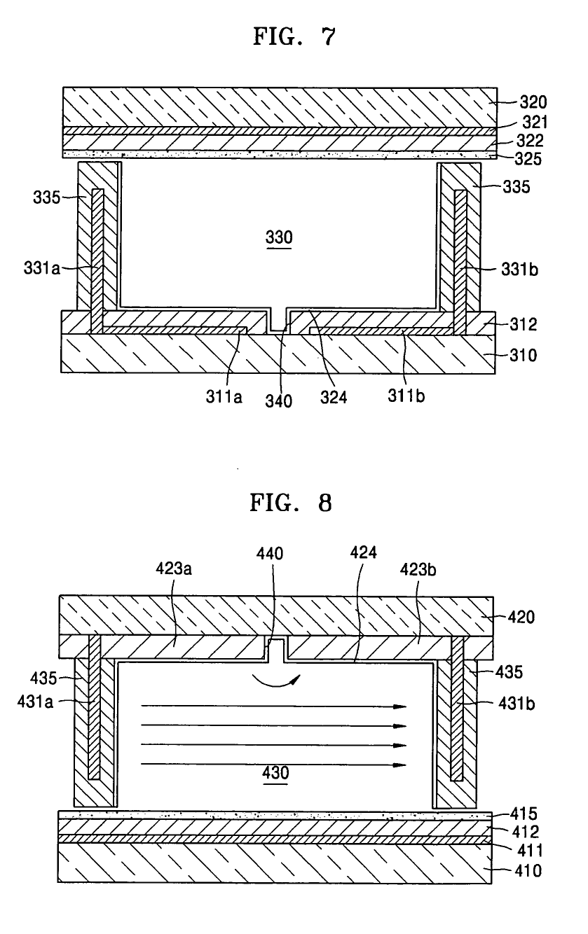

The previous mentioned embodiments may be adopted in a transmittance type PDP. FIG. 7 is a cross sectional view of a PDP according to a third exemplary embodiment of the present invention.

Referring to FIG. 7, a lower substrate 310 and an upper substrate 320 face each other at a predetermined distance with a discharge space therebetween. A plurality of address electrodes 321 is formed on the upper substrate 320, and a transparent first dielectric layer 322 covers the address electrodes 321. The address electrodes 321 may be made of a transparent conductive material so that visible light may pass through the upper substrate 320. Alternatively, the address electrodes 321 may be formed on the lower substrate 310. A fluorescent layer 325 may be formed on the first dielectric layer 322.

A plurality of barrier ribs 335, which partition the discharge space to form discharge cells 330, is arranged between the lower substrate 310 and the upper substrate 320. The barrier ribs 335 are arranged to cross the address electrodes 321.

First and second sustaining electrodes 311a and 311b are formed in pairs on the lower substrate 310 in the discharge cells 330. The first and second sustaining electrodes 311a and 311b are arranged to cross the address electrodes 321. The first and second sustaining electrodes 311a and 311b may be made of a metal such as Ag, or they may be made of ITO or SnO₂. A second dielectric layer 312 covers the first and second sustaining electrodes 311a and 311b. Additionally, a trench 340 of a predetermined shape may be formed substantially parallel to the first and second sustaining electrodes 311a and 311b in a portion of the second dielectric layer 312 between the first and second sustaining electrodes 311a and 311b.

Third and fourth sustaining electrodes 331a and 331b are arranged in and along the length of adjacent barrier ribs 335. The third and fourth electrodes 331a and 331b are formed in pairs and to face each other in the discharge cells 330. The third and fourth sustaining electrodes 331a and 331b may be formed of a metal such as Ag. Furthermore, the third and fourth sustaining electrodes 331a and 331b may be electrically connected with the first and second sustaining electrodes 311a and 311b, respectively.

A protective layer 324 is arranged on the second dielectric layer 312, which covers the first and second sustaining electrodes 311a and 311b, and on the barrier ribs 335, in which the third and fourth sustaining electrodes 331a and 331b are formed.

Although not illustrated in FIG. 7, a DDF may cover portions of the the second dielectric layer 312 corresponding to where the first and second sustaining electrodes 311a and 311b are formed. The DDF may be made of Al₂O₃. In this case, the protective layer 324 may be arranged on the exposed surface of the second dielectric layer 312 and on the surface of the barrier ribs 335. Also, a fluorescent layer (not shown) may be formed on the DDF to generate more visible light during discharge.

FIG. 8 is a cross sectional view of a PDP according to a fourth exemplary embodiment of the present invention.

Referring to FIG. 8, a lower substrate 410 and an upper substrate 420 face each other at a predetermined distance with a discharge space therebetween. A plurality of address electrodes 411 is formed on the lower substrate 410, and a first dielectric layer 412 covers the address electrodes 411. Additionally, a fluorescent layer 415 is formed on the first dielectric layer 412.

A plurality of barrier ribs 435, which partition the discharge space to form discharge cells 430, is arranged between the lower substrate 410 and the upper substrate 420. The barrier ribs 435 are arranged to cross the address electrodes 411. Although not illustrated in FIG. 8, a reflective layer may be formed on the lower substrate 410 to reflect visible light generated in the discharge cells 430 towards the upper substrate 420.

First and second sustaining electrodes 431a and 431b are arranged in and along the length of adjacent barrier ribs 435. The first and second sustaining electrodes 431a and 431b are formed pairs and to face each other in the discharge cells 430. The first and second sustaining electrodes 431a and 431b may be made of a metal such as Ag.

Second and third dielectric layers 423a and 423b are formed on the upper substrate 420 substantially parallel to the barrier ribs 435 and at a predetermined distance from each other. Accordingly, a trench 440 of a predetermined shape is formed between the second and third dielectric layers 423a and 423b. The second and third dielectric layers 423a and 423b may be made of a transparent material so that visible light may pass through the upper substrate 420. The second and third dielectric layers 423a and 423b are coupled with the first and second sustaining electrodes 431a and 431b, respectively. Hence, the second and third dielectric layers 423a and 423b may act as electrodes to which voltages are induced as voltages are applied to the first and second sustaining electrodes 431a and 431b. A protective layer 424 is formed on the second and third dielectric layers 423a and 423b and on the barrier ribs 435.

In the PDP described above, when applying voltages to the first and second sustaining electrodes 431a and 431b, predetermined voltages are induced to the second and third dielectric layers 423a and 423b. Accordingly, a start discharge first occurs between the second and third dielectric layers 423a and 423b, and then a sustain discharge occurs between the first and second sustaining electrodes 431a and 431b. As such, the discharge voltage may be lowered by starting the discharge using the second and third dielectric layers 423a and 423b. Also, luminous efficiency may be increased since the first and second sustaining electrodes 431a and 431b generate a facing discharge, which has a long discharge path, inside the discharge cells 430 during sustain discharge.

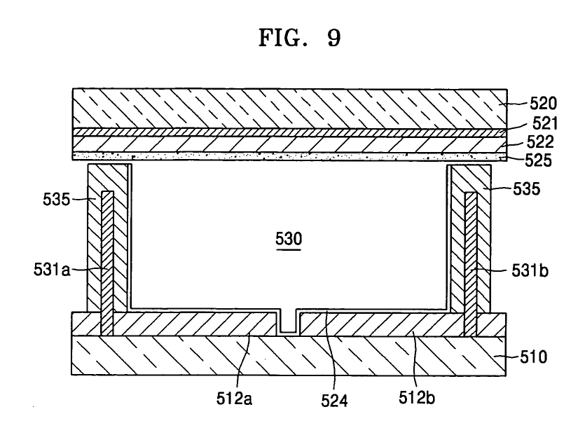

The previous mentioned embodiments may be adopted in a transmittance type PDP. FIG. 9 is a cross sectional view of a PDP according to a fifth exemplary embodiment of the present invention.

Referring to FIG. 9, a lower substrate 510 and an upper substrate 520 face each other at a predetermined distance with a discharge space therebetween. A plurality of address electrodes 521 is formed on the upper substrate 520, and a transparent first dielectric layer 522 covers the address electrodes 521. The address electrodes 521 may be made of a transparent conductive material. Alternatively, the address electrodes 521 may be formed on the lower substrate 510. A fluorescent layer 525 may be formed on the first dielectric layer 522.

A plurality of barrier ribs 535, which partition the discharge space to form discharge cells 530, is arranged between the lower substrate 510 and the upper substrate 520. The barrier ribs 535 are arranged to cross the address electrodes 521.

First and second sustaining electrodes 531a and 531b are arranged in and along the length of adjacent barrier ribs 535. The first and second sustaining electrodes 531a and 531b are formed in pairs and to face each other in the discharge cells 530. The first and second sustaining electrodes 531a and 531b may be made of a metal such as Ag.

Second and third dielectric layers 512a and 512b are formed on the lower substrate 510 substantially parallel to the barrier ribs 535 and at a predetermined distance from each other. The second and third dielectric layers 512a and 512b are coupled with the first and second sustaining electrodes 531a and 531b, respectively. As described in the previous embodiment, the second and third dielectric layers 512a and 512b act as electrodes to which voltages are induced as voltages are applied to the first and second sustaining electrodes 531a and 531b. A protective layer 524 is formed on the second and third dielectric layers 512a and 512b and on the barrier ribs 535.

In the PDP described above, the discharge voltage may be reduced by starting the discharge using the second and third dielectric layers 512a and 512b. Also, luminous efficiency may be enhanced since the first and second sustaining electrodes 531a and 531b generate a facing discharge, which has a long discharge path, inside the discharge cells 530 during sustain discharge.

According to a PDP of the present invention described above, by having a pair of sustaining electrodes not only on a substrate but also inside barrier ribs, a hybrid discharge, which is a combination of a facing discharge and a surface discharge, may be generated. Consequently, the discharge voltage may be reduced by the field enhancement effect. Furthermore, a substantially uniform electric field may be formed inside discharge cells, thereby improving luminous efficiency.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a lower substrate and an upper substrate facing each other with a discharge space therebetween;
a plurality of barrier ribs arranged between the lower substrate and the upper substrate and partitioning the discharge space to form a plurality of discharge cells;
a plurality of address electrodes arranged on the lower substrate;
a first dielectric layer covering the address electrodes;
a first fluorescent layer arranged on the first dielectric layer;
a first sustaining electrode and a second sustaining electrode in the discharge cells, the first sustaining electrode and the second sustaining electrode being arranged on the upper substrate;
a second dielectric layer covering the first sustaining electrode and the second sustaining electrode; and
a third sustaining electrode and a fourth sustaining electrode facing each other in the discharge cells, the third sustaining electrode and the fourth sustaining electrode being arranged in the barrier ribs,
wherein a surface discharge occurs between the first sustaining electrode and the second sustaining electrode, and a facing discharge occurs between the third sustaining electrode and the fourth sustaining electrode.

2. The PDP of claim 1, wherein the first sustaining electrode, the second sustaining electrode, and the barrier ribs are arranged to cross the address electrodes, and the third sustaining electrode and the fourth sustaining electrode are arranged along a length of the barrier ribs.

3. The PDP of claim 2, further comprising:
a trench formed in the second dielectric layer,
wherein the trench is formed between the first sustaining electrode and the second sustaining electrode.

4. The PDP of claim 2, further comprising:
a protective layer,
wherein the protective layer is arranged on a portion of the second dielectric layer corresponding to the first sustaining electrode and the second sustaining electrode, and on a portion of the barrier ribs corresponding to the third sustaining electrode and the fourth sustaining electrode.

5. The PDP of claim 2, wherein the first sustaining electrode and the second sustaining electrode comprise a transparent conductive material, and the third sustaining electrode and the fourth sustaining electrode comprise a metal.

6. The PDP of claim 5, wherein the first sustaining electrode and the second sustaining electrode comprise one of indium tin oxide and tin dioxide.

7. The PDP of claim 5, wherein the first sustaining electrode and the second sustaining electrode are electrically connected with the third sustaining electrode and the fourth sustaining electrode, respectively.

8. The PDP of claim 5, further comprising:
a trench formed in the second dielectric layer,
wherein the trench is formed between the first sustaining electrode and the second sustaining electrode.

9. The PDP of claim 5, further comprising:
a protective layer,
wherein the protective layer is arranged on the second dielectric layer and the barrier ribs.

10. The PDP of claim 5, further comprising:
a discharge deactivation film,
wherein the discharge deactivation film is arranged on a portion of the second dielectric layer.

11. The PDP of claim 10, wherein the discharge deactivation film comprises aluminum oxide.

12. The PDP of claim 10, further comprising:
a second fluorescent layer,
wherein the second fluorescent layer is arranged on the discharge deactivation film.

13. The PDP of claim 1, further comprising:
a reflective layer,
wherein the reflective layer is arranged on the lower substrate to reflect visible light generated in the discharge cells towards the upper substrate.

14. A plasma display panel (PDP), comprising:
a lower substrate and an upper substrate facing each other with a discharge space therebetween;
a plurality of barrier ribs arranged between the lower substrate and the upper substrate and partitioning the discharge space to form a plurality of discharge cells;
a plurality of address electrodes arranged on the upper substrate;
a first dielectric layer covering the address electrodes;
a first fluorescent layer arranged on the first dielectric layer;
a first sustaining electrode and a second sustaining electrode in the discharge cells, the first sustaining electrode and the second sustaining electrode being arranged on the lower substrate;
a second dielectric layer covering the first sustaining electrode and the second sustaining electrode; and
a third sustaining electrode and a fourth sustaining electrode facing each other in the discharge cells, the third sustaining electrode and the fourth sustaining electrode being arranged in the barrier ribs,
wherein a surface discharge occurs between the first sustaining electrode and the second sustaining electrode, and a facing discharge occurs between the third sustaining electrode and the fourth sustaining electrode.

15. The PDP of claim 14, wherein the first sustaining electrode, the second sustaining electrode, and the barrier ribs are arranged to cross the address electrodes, and the third sustaining electrode and the fourth sustaining electrode are arranged along a length of the barrier ribs.

16. The PDP of claim 15, wherein the first sustaining electrode and the second sustaining electrode are electrically connected with the third sustaining electrode and the fourth sustaining electrode, respectively.

17. The PDP of claim 15, further comprising:
a trench formed in the second dielectric layer,
wherein the trench is formed between the first sustaining electrode and the second sustaining electrode.

18. The PDP of claim 15, further comprising:
a protective layer,
wherein the protective layer is arranged on the second dielectric layer and the barrier ribs.

19. The PDP of claim 15, further comprising:
a discharge deactivation film,
wherein the discharge deactivation film is arranged on a portion of the second dielectric layer.

20. The PDP of claim 19, wherein the discharge deactivation film comprises aluminum oxide.

21. The PDP of claim 19, further comprising:
a second fluorescent layer,
wherein the second fluorescent layer is arranged on the discharge deactivation film.

22. A plasma display panel (PDP), comprising:
a lower substrate and an upper substrate facing each other with a discharge space therebetween;
a plurality of barrier ribs arranged between the lower substrate and the upper substrate and partitioning the discharge space to form a plurality of discharge cells;
a plurality of address electrodes arranged on the lower substrate;
a first dielectric layer covering the address electrodes;
a fluorescent layer arranged on the first dielectric layer;
a first sustaining electrode and a second sustaining electrode facing each other in the discharge cells, the first sustaining electrode and the second sustaining electrode being arranged in the barrier ribs; and
a second dielectric layer and a third dielectric layer on the upper substrate and spaced apart from each other, the second dielectric layer and the third dielectric layer being coupled with the first sustaining electrode and the second sustaining electrode, respectively, so that voltages are induced to the second dielectric layer and the third dielectric layer as voltages are applied to the first sustaining electrode and the second sustaining electrode,
wherein a facing discharge occurs between the first sustaining electrode and the second sustaining electrode, and a surface discharge occurs between the second dielectric layer and the third dielectric layer.

23. The PDP of claim 22, wherein the barrier ribs are arranged to cross the address electrodes, and the first sustaining electrode and the second sustaining electrode are arranged along a length of the barrier ribs.

24. The PDP of claim 23, wherein the second dielectric layer and the third dielectric layer are arranged substantially parallel with the barrier ribs.

25. The PDP of claim 24, further comprising:
a protective layer,
wherein the protective layer is arranged on the second dielectric layer, the third dielectric layer, and the barrier ribs.

26. The PDP of claim 22, further comprising:
a reflective layer,
wherein the reflective layer is arranged on the lower substrate to reflect visible light generated in the discharge cells towards the upper substrate.

27. A plasma display panel (PDP), comprising:
a lower substrate and an upper substrate facing each other with a discharge space therebetween;
a plurality of barrier ribs arranged between the lower substrate and the upper substrate and partitioning the discharge space to form a plurality of discharge cells;
a plurality of address electrodes arranged on the upper substrate;
a first dielectric layer covering the address electrodes;
a fluorescent layer arranged on the first dielectric layer;
a first sustaining electrode and a second sustaining electrode facing each other in the discharge cells, the first sustaining electrode and the second sustaining electrode being arranged in the barrier ribs; and
a second dielectric layer and a third dielectric layer on the lower substrate and spaced apart from each other, the second dielectric layer and the third dielectric layer being coupled with the first sustaining electrode and the second sustaining electrode, respectively, so that voltages are induced to the second dielectric layer and the third dielectric layer as voltages are applied to the first sustaining electrode and the second sustaining electrode,
wherein a facing discharge occurs between the first sustaining electrode and the second sustaining electrode, and a surface discharge occurs between the second dielectric layer and the third dielectric layer.

28. The PDP of claim 27, wherein the barrier ribs are arranged to cross the address electrodes, and the first sustaining electrode and the second sustaining electrode are arranged along a length of the barrier ribs.

29. The PDP of claim 28, wherein the second dielectric layer and the third dielectric layer are arranged substantially parallel with the barrier ribs.

30. The PDP of claim 29, further comprising:
a protective layer,
wherein the protective layer is arranged on the second dielectric layer, the third dielectric layer, and the barrier ribs.
